(19) United States
(12) Patent Application Publication
(10) Pub. No.: US 2026/0100599 A1
(43) Pub. Date: Apr. 9, 2026

(54) METHOD AND SYSTEM FOR CHARGING A BATTERY

(71) Applicant: COMMISSARIAT A L'ENERGIE ATOMIQUE ET AUXENERGIES ALTERNATIVES, PARIS (FR)

(72) Inventors: Lara CASIEZ, GRENOBLE CEDEX 09 (FR); Jacopo CELE, GRENOBLE CEDEX 09 (FR)

(73) Assignee: COMMISSARIAT A L'ENERGIE ATOMIQUE ET AUX ENERGIES ALTERNATIVES, PARIS (FR)

(21) Appl. No.: 19/348,918

(22) Filed: Oct. 3, 2025

(30) Foreign Application Priority Data
Oct. 4, 2024 (FR) FRFR2410736

(51) Int. Cl. H02J 7/00

(52) U.S. Cl. CPC H02J 7/663; H02J 7/80

(57) ABSTRACT

A method for charging a battery, including the steps of charging the battery by application of a charge voltage to the terminals of the battery; and interrupting the charge when the differential between the charge voltage and the no-load voltage of the battery is below a margin so as to protect the internal resistance of the battery.

### CROSS-REFERENCE TO RELATED APPLICATIONS

This application claims priority to French Patent Application No. FR2410736, filed on Oct. 4, 2024, the entire contents of which are incorporated herein by reference.

### FIELD OF THE INVENTION

The invention relates to the monitoring of the charge of a battery in order to avoid its degradation over time as the charge and discharge cycles progress.

### STATE OF THE ART

A battery, in particular a lithium-ion battery comprises several cells including a rechargeable electrochemical system to provide a nominal voltage.

With the development of the electrical systems operating by means of a rechargeable battery, in particular the electric vehicles, the charge time of the battery is to be optimized.

To quickly charge a battery, significant charge voltages must be used. However, the higher the voltages used, the faster the battery degrades over its usage cycles.

There is a need to optimize a battery charge that strikes a balance between battery life and charge time.

### DISCLOSURE OF THE INVENTION

The invention allows monitoring the charge of a battery in order to prevent its rapid degradation.

To this end, the invention proposes, according to a first aspect, a method for charging a battery, comprising the following steps:
charging the battery by application of a charge voltage to the terminals of the battery;
interrupting the charge when the differential between the charge voltage and the no-load voltage of the battery is below a margin so as to protect the internal resistance of the battery.

The method according to the first aspect is supplemented by the following characteristics, alone or in combination:
after a first full charge of the battery, the method comprises the following steps: obtaining a measurement of the current circulating in the battery during the application of the charge voltage; determining the differential between the charge voltage and the no-load voltage of the battery as a function of the measured current and of the internal resistance of the battery; interrupting the charge as soon as the determined differential is below the margin ensuring a no-load voltage of the battery lower than the charge voltage;
the differential between the charge voltage and the no-load voltage of the battery is determined by Rᵢₙₜ. Iₛ, with Iₛ is the measured current and Rᵢₙₜ is the internal resistance of the battery.
the internal resistance of the battery is measured at the first full charge, the battery being fully charged at the first charge when the differential between the charge voltage and the no-load voltage of the battery is below the margin protecting the internal resistance of the battery.
the internal resistance of the battery is measured before the application of the charge voltage, preferably every 10 to 100 charges.
the margin is comprised between 10 mV and 250 mV, preferably 100 mV;
before the charge of the battery, a step of measuring the no-load voltage at the terminals of the battery, the charge beginning if the measured voltage is below a threshold from which the internal resistance of the battery is no longer protected.
at the first charge, the method comprises the following steps: a) charging the battery for a maximum duration, preferably between 10 seconds and 100 seconds, typically 60 seconds; b) measuring the internal resistance of the battery; c) measuring the no-load voltage at the terminals at the end of the determined duration; d) determining a differential between the charge voltage and the no-load voltage; repeating steps a) to d) as long as the differential between the charge voltage and the no-load voltage of the battery is above the margin protecting the internal resistance of the battery, the method comprising during step a): e) measuring the current circulating in the battery during the charge; f) determining the differential between the charge voltage and the no-load voltage of the battery as a function of the measured current and of the internal resistance of the battery; g) interrupting the charge if the determined differential is below the margin.

The invention proposes, according to a second aspect, a charging system comprising a processor for the implementation of the method according to the first aspect of the invention.

The invention proposes, according to a third aspect, a computer program product comprising program code instructions for the execution of the steps of the method according to the first aspect of the invention when the program is executed on a computer.

### DESCRIPTION OF THE FIGURES

Other characteristics, aims, and advantages of the invention will emerge from the following description, which is purely illustrative and non-limiting, and which should be read in relation to the appended drawings, in which:

FIG. 1 represents an equivalent diagram of a battery and of a system for charging the battery.

FIG. 2 represents curves showing the evolution of the internal resistance of several batteries as a function of an off-load (or open-circuit) voltage measured at the terminals of the battery for different charge voltages of the battery.

FIG. 3 illustrates a charging method according to a first embodiment of the invention.

FIG. 4 illustrates a charging method according to a second embodiment of the invention.

Throughout the figures, the similar elements bear identical references.

### DETAILED DESCRIPTION OF THE INVENTION

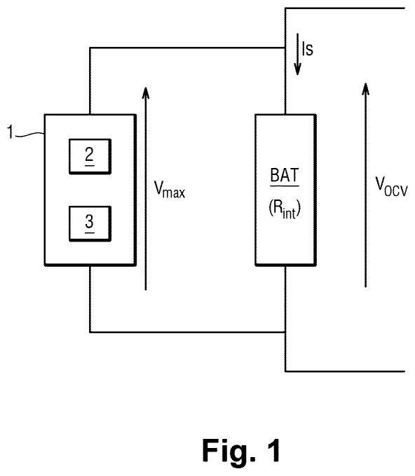

FIG. 1 illustrates a battery BAT (for example Lithium-Ion) rechargeable by means of a system 1 for charging a battery comprising a processor 2 configured to implement a charging method described below. The charging system 1 is preferably integrated within a battery charger, for example a battery charger for example of an electric vehicle. The charging system 1 also comprises a memory 3 for storing different values used during the charging method. The processor 2 is configured to obtain several measurements in particular a measurement of the no-load voltage V_{OCV} (that is to say the voltage when the battery is disconnected from any circuit) at the terminals of the battery characteristic of the state of charge of the battery BAT, a measurement of the current Iₛ circulating in the battery BAT. The processor 2 is also configured to control the application of a charge voltage Vₘₐₓ to the terminals of the battery BAT, and to process the different measurements and more generally to control the charge of the battery BAT.

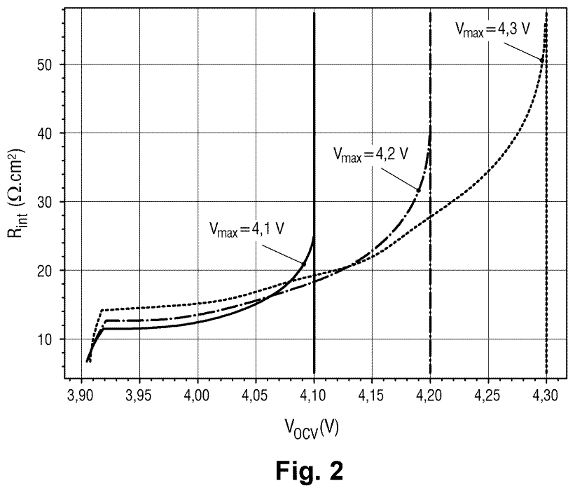

The idea of the method of the invention is to protect the battery BAT in order to prevent its internal resistance, denoted Rᵢₙₜ, from degrading during its charge. Indeed, it has been observed that when the no-load voltage V_{OCV} at the terminals of the battery approaches the charge voltage Vₘₐₓ (or setpoint), the internal resistance Rᵢₙₜ degrades, impacting the battery life. Such a phenomenon is illustrated in FIG. 2 which shows curves of the evolution of the internal resistance Rᵢₙₜ as a function of the no-load voltage V_{OCV} measured at the terminals of the battery, and this for several batteries. Each curve corresponds to a charge voltage Vₘₐₓ (4.1 V, 4.2 V, 4.3 V) for different batteries. According to these curves, it is observed that the internal resistance Rᵢₙₜ increases almost exponentially as the no-load voltage V_{OCV} approaches the charge voltage Vₘₐₓ. However, the more this internal resistance Rᵢₙₜ increases, the more quickly the battery BAT degrades.

Consequently, it is proposed to prevent the no-load voltage V_{OCV} from reaching this charge voltage Vₘₐₓ during the charge of the battery. Thus, a margin η=Vₘₐₓ−V_{OCV} guaranteeing a no-load voltage V_{OCV} measured at the terminals of the battery lower than the charge voltage Vₘₐₓ is defined. Such a margin depends on the battery and is typically η<100 mV for an all solid-state battery. The monitoring of the no-load voltage V_{OCV} is therefore relevant for optimizing the charge of the battery. The monitoring of this no-load voltage is carried out either by direct measurement or by measuring the current according to either of the embodiments described below.

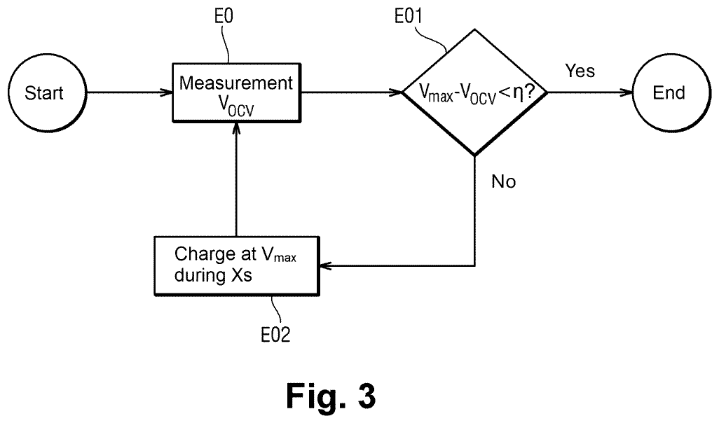

According to a first embodiment, illustrated in FIG. 3, at the beginning of the method, the system measures the no-load voltage V_{OCV} at the terminals of the battery (step E0). If a potential difference between the charge voltage Vₘₐₓ and the no-load voltage V_{OCV} is above the margin η (step E01) then the charge starts by application of the charge voltage Vₘₐₓ (step E02) for a determined duration (Xs) typically between 10 seconds and 100 seconds, preferably 60 seconds. The charge voltage Vₘₐₓ is typically comprised between 4.1 V and 10 V but can vary as a function of the battery type. At the end of this duration, the no-load voltage V_{OCV} at the terminals of the battery (step E0) is measured, and the charge continues as long as the potential difference between the charge voltage Vₘₐₓ and the no-load voltage V_{OCV} is above the margin η; otherwise, it ends. According to this first embodiment, the internal resistance of the battery is protected, and it is necessary to interrupt the charge to measure the no-load voltage V_{OCV}.

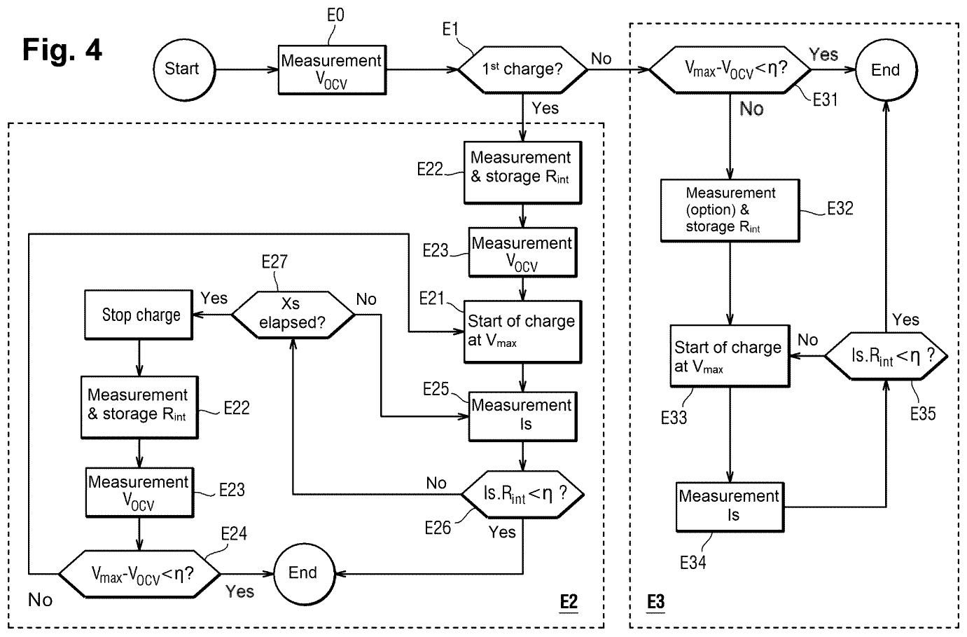

According to a second embodiment, illustrated in FIG. 4, to improve the charge time, it is the current circulating in the battery that is measured to avoid having to interrupt the charge during normal use after the first charge.

According to this second embodiment, at the beginning of the method, the system detects (step E1) whether it is the first charge of the battery (that is to say that it has never been charged) and measures the no-load voltage V_{OCV} at the terminals of the battery (step E0). The detection of the first charge depends on the type of battery. At the first charge of the battery, a conditioning of the battery is carried out (step E2), which consists in fully charging the battery, that is to say up to the charge limit such that a potential difference between the charge voltage and the no-load voltage V_{OCV} is below the margin η. To do so, the charge voltage is applied (step E21) to the battery for a maximum duration (Xs), for example between 10 seconds and 100 seconds, preferably 60 seconds. At the end of this duration, the application of the charge voltage Vₘₐₓ is interrupted and the internal resistance Rᵢₙₜ of the battery is measured as well as the no-load voltage V_{OCV} (steps E22 and E23). These periods of charge and measurement of the resistance and voltage are repeated as long as the potential difference between the charge voltage and the no-load voltage is above the margin η, this difference being calculated and compared with the margin (step E24). As soon as this potential difference is below the margin, the conditioning is interrupted.

During the charge, the current Is circulating in the battery is also measured (step E25) and the product of the measured current to the last measured internal resistance Rᵢₙₜ of the battery is determined (step E26). If this product is below the margin η, then the charge at the voltage Vₘₐₓ is interrupted; otherwise, it continues as long as this product is above the margin η and as long as the duration Xs has not elapsed (step E27). This allows protecting the internal resistance Rᵢₙₜ of the battery during the charge period.

During the next charges (step E3), the state of charge is first verified by measuring the no-load voltage V_{OCV} (step E31). If the potential difference between the charge voltage and the no-load voltage V_{OCV} is above the margin, then the charge starts; otherwise, the charge is not carried out and the method is interrupted.

Before starting the charge, a measurement of the internal resistance of the battery is performed and this value is stored (step E32). This measurement is not systematically necessary because the charging system can use the measurement of the internal resistance of the battery at the end of the first charge. This is particularly true if this resistance does not vary over time. Of course, if this measurement is not available, then the measurement of the internal resistance is performed. This measurement can be made periodically every N charge cycles, with N comprised between 10 and 100.

Then, the charge voltage is applied (step E33) and, during the charge, the current Is circulating in the battery is measured (step E34). Then, the product of the measured current and of the internal resistance of the battery is determined (step E35). If this product is below the margin, then the charge is interrupted; otherwise, it continues as long as this ratio is above the margin.

In other words, it is verified whether Iₛ<η/Rᵢₙₜ. Indeed, when a voltage is applied to a battery, which has a certain no-load voltage V_{OCV}, it is the difference between V_{OCV} and Vₘₐₓ that determines the current and not directly Vₘₐₓ. Consequently, the product between the internal resistance Rᵢₙₜ of the battery and the current Iₛ circulating in the battery is given by the margin η. This is also because the no-load voltage V_{OCV} is measured relative to the ground and not relative to the potential of the battery. The no-load voltage V_{OCV} and the voltage Vₘₐₓ are referenced relative to the ground and not to each other (Vₘₐₓ is not a potential difference, but an absolute value).

1. A method for charging a battery (BAT), comprising the following steps:
charging (E01, E21, E33) the battery (BAT) by application (E02, E21, E33) of a charge voltage (Vₘₐₓ) to the terminals of the battery (BAT);
interrupting (E01, E31, E35) the charge when the differential between the charge voltage (Vₘₐₓ) and the no-load voltage (V_{OCV}) of the battery (BAT) is below a margin (η) so as to protect the internal resistance of the battery.

2. The method according to claim 1, comprising the following steps, implemented after a first full charge (E2) of the battery (BAT):
obtaining (E34) a measurement of the current (Iₛ) circulating in the battery (BAT) during the application of the charge voltage (Vₘₐₓ);
determining (E35) the differential between the charge voltage (Vₘₐₓ) and the no-load voltage (V_{OCV}) of the battery (BAT) as a function of the measured current (Iₛ) and of the internal resistance (Rᵢₙₜ) of the battery (BAT);
interrupting the charge as soon as the determined differential is below the margin (η) ensuring a no-load voltage (V_{OCV}) of the battery (BAT) lower than the charge voltage (Vₘₐₓ).

3. The method according to claim 2, wherein the differential between the charge voltage and the no-load voltage (V_{OCV}) of the battery (BAT) is determined (E35) by Rᵢₙₜ. Iₛ, with Iₛ the measured current and Rᵢₙₜ the internal resistance of the battery.

4. The method according to claim 3, wherein the internal resistance (Rᵢₙₜ) of the battery is measured (E22) at the first full charge, the battery being fully charged at the first charge (E2) when the differential between the charge voltage and the no-load voltage (V_{OCV}) of the battery is below the margin (η) protecting the internal resistance of the battery.

5. The method according to claim 3, wherein the internal resistance (Rᵢₙₜ) of the battery is measured (E32) before the application of the charge voltage, preferably every 10 to 100 charges.

6. The method according to claim 1, wherein the margin (η) is comprised between 10 mV and 250 mV, preferably 100 mV.

7. The method according to claim 1, comprising, before the charge of the battery, a step of measuring (E0) the no-load voltage (V_{OCV}) at the terminals of the battery, the charge beginning if the measured voltage is below a threshold from which the internal resistance of the battery is no longer protected.

8. The method according to claim 1, wherein at the first charge (E2), the method comprises the following steps:
a) charging (E21) the battery for a maximum duration (X), preferably between 10 seconds and 100 seconds, typically 60 seconds;
b) measuring (E22) the internal resistance of the battery;
c) measuring (E23) the no-load voltage (V_{OCV}) at the terminals at the end of the determined duration;
d) determining (E24) a differential between the charge voltage and the no-load voltage (Vₘₐₓ−V_{OCV});
repeating steps a) to d) as long as the differential between the charge voltage and the no-load voltage (V_{OCV}) of the battery is above the margin (η) protecting the internal resistance of the battery, the method comprising, during step a),
e) measuring (E25) the current (Is) circulating in the battery (BAT) during the charge;
f) determining (E26) the differential between the charge voltage (Vₘₐₓ) and the no-load voltage (V_{OCV}) of the battery (BAT) as a function of the measured current (Is) and of the internal resistance (Rᵢₙₜ) of the battery (BAT);
g) interrupting (E26) the first charge if the determined differential is below the margin (η).

9. A system (1) for charging a battery comprising a processor (1) for the implementation of a method according to claim 1.

10. A computer program product comprising program code instructions for the execution of the steps of the method according to claim 1, when the program is executed on a computer.
